(19) United States
(12) Patent Application Publication
(10) Pub. No.: US 2003/0157446 A1
(43) Pub. Date: Aug. 21, 2003

(54) Silver halide photographic material showing improved latent image stability

(76) Inventor: Kris Viaene, Bonheiden (BE)

Correspondence Address: Joseph T. Guy Ph.D., Nexsen Pruet Jacobs & Pollard LLP, 201 W. McBee Avenue, Greenville, SC, 29603, US

(21) Appl. No.: 10/267,562

(22) Filed: Oct. 9, 2002

Related U.S. Application Data
(60) Provisional application No. 60/337,181, filed on Dec. 4, 2001.

(30) Foreign Application Priority Data
Oct. 25, 2001 (EP) 01000570.0

(51) Int. Cl. G03C 1/015; G03C 1/035; G03C 1/34

(52) U.S. Cl. 430/567; 430/569; 430/614

(57) ABSTRACT

A silver halide photosensitive material has been provided which has, in at least one light-sensitive emulsion layer thereof, a silver halide emulsion comprising grains or crystals rich in silver chloride, which grains have been chemically sensitized in a specific way in the presence of a substituted phenyl-mercaptotetrazole compound according to the formula represented in the detailed description and in the claims, said compound having been added at the end of chemical sensitization, and, moreover the method of preparing said material has been claimed.

### FIELD OF THE INVENTION

The present invention relates in general to a silver halide light-sensitive material and in particular to a photographic “Motion Picture Print Film”. More specifically this invention relates to a Motion Picture Print Film characterized by an excellent latent image stability, otherwise expressed as showing little change in sensitivity in the time interval between exposure and processing.

### BACKGROUND OF THE INVENTION

A Motion Picture Print film, the film that is shown in movie theatres, contains besides the motion picture image optical sound tracks along at least one edge of the film. In order to optimize the visual guality of the motion picture image as well as the sound quality of the sound track recorded on a motion picture, the motion picture and sound tracks are first typically captured or recorded on separate photosensitive films as negative images, and the resulting negatives are then printed in synchronization on the motion picture film to form positive images. This printing is performed in so-called print laboratories.

In normal conditions the time between printing (exposure of the motion picture film) and processing is limited. It is however possible that between exposure and processing, the time delay can amount to several days. In such conditions it is important that the sensitivity of the motion picture film does not change between exposure and processing, or otherwise expressed, that the latent image formed upon exposure does not alter between exposure and processing.

Photographic Motion Picture Print Films typically use high chloride emulsions to enable rapid processing.

Since the blue-sensitive layer in a typical Motion Picture Film is situated nearest to the undercoat, a high sensitive emulsion is needed which consists almost entirely of silver chloride in order to enable rapid processing.

Such high sensitive emulsions emulsions rich in silver chloride can however show a large change in sensitivity in the time interval between exposure and development.

### OBJECTS OF THE INVENTION

It is an object of the present invention to provide a method of preparing a material excellent in rapid processing ability and showing little change of the sensitivity between the time of exposure and the processing, even if this time amounts to several days.

More particularly an object of the present invention is to provide a method of processing a color print photographic material by a rapid color development system.

Futher objects will become apparent from the description hereinafter.

### SUMMARY OF THE INVENTION

The above mentioned objects have been realized by providing a silver halide photosensitive material which has in at least one light-sensitive emulsion layer thereof a silver halide emulsion comprising grains or crystals rich in silver chloride, wherein said grains have been chemically sensitized in the presence of a substituted phenyl-mercaptotetrazole compound, and more preferably an acetamidophenyl mercaptotetrazole compound, according to the formula represented in the detailed description and in the claims. A method of preparing such an emulsion preferably comprises the steps of precipitating cubic crystals rich in silver chloride (up to 100 mole % of AgCl) by double jet in an aqueous medium containing a protective colloid, flocculating, washing and redispersing said emulsion by addition of a binder material; adjusting pH and pAg up to suitable values and adding, prior to chemical sensitization, a compound releasing iodide ions, followed, after digestion, by consecutively adding, as chemical sensitizing agents, a gold compound, an oxidizing compound and a compound releasing sulphur;

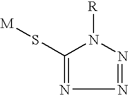

chemically sensitizing said cubic emulsion crystals; characterized by the step of adding, immediately after ending said chemically sensitizing step, before cooling, a compound according to the general formula (I)

(I)

wherein R represents a substituted aryl and wherein M represents a hydrogen atom, an alkali metal atom or an ammonium group.

A silver halide material prepared according to the method of the present invention has also been claimed and, more particularly, a color print material, wherein the emulsion prepared according to the method of the present invention is coated in at least one of the emulsion layers sensitive to a different wavelength range.

The particular agent added to the emulsion before chemically sensitizing it corresponds to the general formula (I).

Specific features for preferred embodiments of the invention are set out in the dependent claims.

Further advantages and embodiments of the present invention will become apparent from the following description.

### DETAILED DESCRIPTION OF THE INVENTION

The method of the present invention thus applied as set forth hereinbefore suppresses the increase in the fog density, further saving the photographic sensitivity in an environment wherein changes of heat and humidity appear during storage or preservation of the material and, more particularly, between the time of exposure and the processing of said material.

Moreover the effect of the invention resides in a quick processability (rapid processing application) by this invention, providing a low fog and high speed.

The compound added at the end of chemical sensitization step is the compound according to the general formula (I) hereinafter

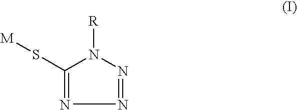

wherein R represents a substituted aryl and wherein M represents a hydrogen atom, an alkali metal atom or an ammonium group.

Preferred substituted mercapto-tetrazole compounds according to the general formula (I), are represented hereinafter in the formulae (I.1-I.12):

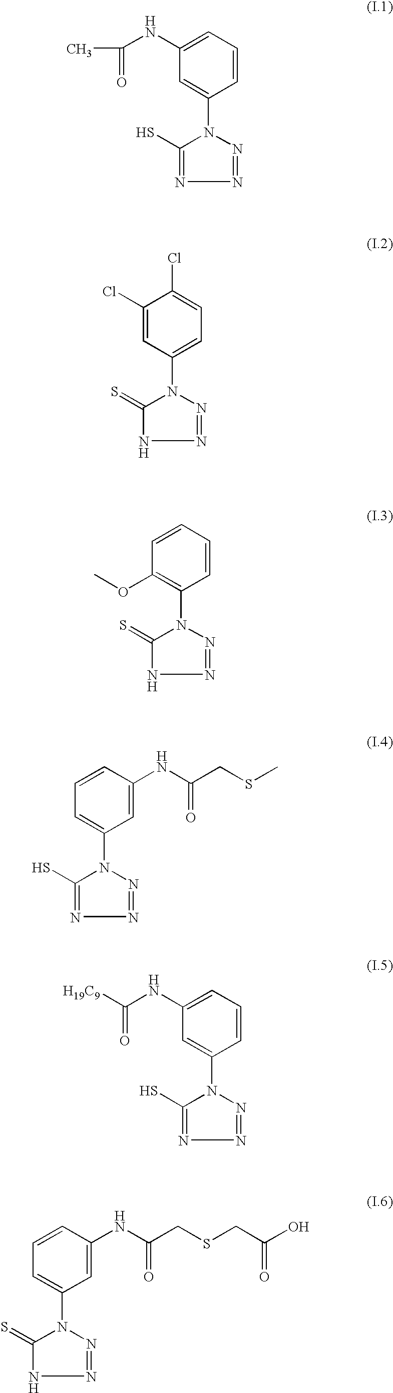

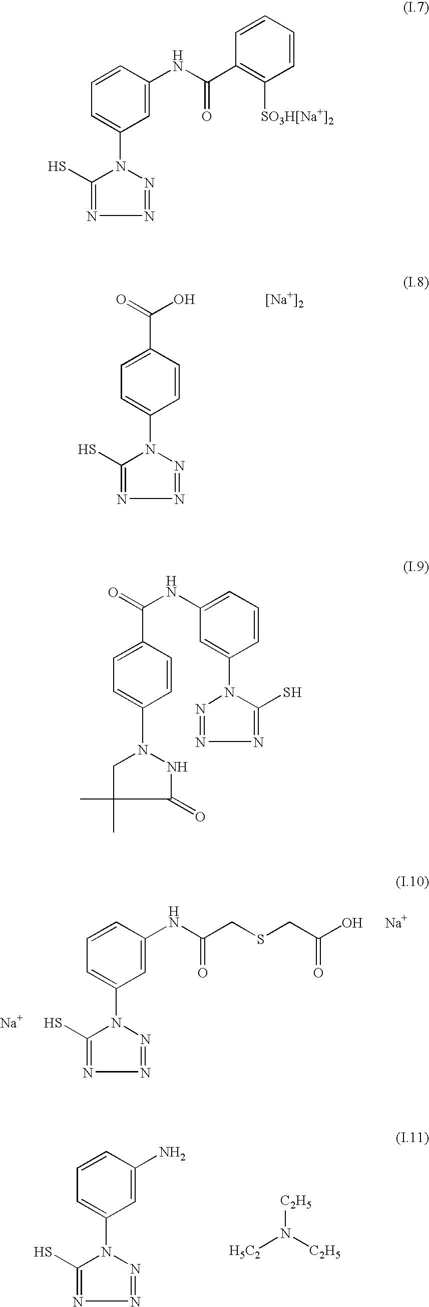

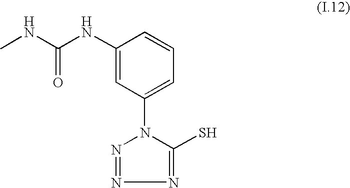

According to the present invention one or more of those compounds are added in a preferred total amount in a range of from 0.01 up to 1 mmole per mole of silver halide.

According to a preferred embodiment of the present invention, immediately after ending chemical sensitization, thus just before starting cooling, during and/or at the end of the cooling process of the chemically sensitized emulsion, at least one of the mercaptote-trazole compounds, and more preferred, the acetamidophenyl mercapto-tetrazole compounds (see more particularly the compounds I.1, I.4, I.6, I.10 and I.12) are added, in order to fully attain the objects of the present invention.

The method of preparing an emulsion according to the present invention starts with the preparation of an emulsion in an aqueous medium containing a protective colloid, said method comprising the steps of precipitating cubic emulsion crystals rich in silver chloride,flocculating, washing and redispersing by addition of a binder material; adjusting pH and pAg; adding, prior to chemical sensitization, a compound releasing iodide ions; adding as chemical sensitizing agents consecutively, a gold compound, an oxidizing compound and a compound releasing sulphur; chemically sensitizing by digestion at a controlled temperature said cubic emulsion crystals; and as characterizing feature that, immediately after ending said chemically sensitizing step by starting cooling the emulsion to a lower temperature than the controlled temperature during the effective chemical ripening or sensitization process, addition of a substituted phenyl-mercaptotetrazole compound according to formula (I), set forth above, proceeds.

During the whole preparation process of the cubic grain emulsion temperature controll is very important: before starting precipitating cubic crystals rich in silver chloride (up to 100 mole % of AgCl) by double jet in an aqueous medium containing a protective colloid, the reaction vessel containing said aqueous medium is already temperature controlled, at least at a temperature exceeding the temperature at which the protective colloid solidifies. As, according to the method of the present invention said protective colloid is selected from the group consisting of gelatin (whether or not chemically modified) , silica sol, (cationic) (oxidized or non-oxidized) starch or mixtures thereof, being representative, but not limitative for organic and inorganic binders respectively, it depends on the choice thereof what temperature for the reaction vessel is chosen in order to prepare a homogeneous aqueous medium wherein the precipitation reaction can start. In general in the preparation step of the reaction vessel a temperature of about 40° C. up to 50° C. is chosen when gelatin, whether or not modified as e.g. phthaloyl or (phenyl)carbamoyl gelatin, whether or not oxidized in order to reduce the amount of methionin therein, and whether or not demineralized in order to have a lower calcium ion content, is taken as (most preferred) protective colloid.

A preferred precipitation technique in order to get cubic crystals rich in silver chloride is the double-jet method, wherein the silver ion concentration is controlled during the precipitation and wherein the flow rate of the reacting solutions is enhanced as the precipitation proceeds. The flow rate is controlled at such a rate that no renucleation appears. This method offers the possiblity to get well-defined crystals having a regular cubic habit within a short precipitation time, which is also dependent on the reaction temperature in the reaction vessel, which is normally increased before starting precipitation from about 40° C.-45° C. up to 55-65° C.

According to the method of the present invention, the precipitation step is performed in order to get cubic emulsion crystals rich in silver chloride having an average edge length of from 0.1 μm up to 1.0 μm (more preferably from 0.2 up to 0.8 μm).

Further according to the method of the present invention said cubic emulsion grains rich in silver chloride have at least 50 mole % of silver chloride, based on silver; and silver bromide, if present, in a molar amount of not more than 20 mole %, more preferably not more than 10 mole %, based on silver. Although the silver bromide content may be divided homogeneously over the whole cubic crystal volume, a so-called localization phase with high silver-bromide content may be present as an internal shell in the cubic crystal. It should however be avoided to get too high a silver bromide content as pressure, applied to such a sensitive material, may cause desensitization. So the silver bromide content of a localization phase with high silver bromide content preferably is in the range between 20-50 mole % range. Such a silver bromide content of a localized phase with high silver bromide content can be analyzed using an X-ray diffraction method.

As a binder material the preferred gelatin may further be replaced in part or integrally by synthetic, semi-synthetic, or natural polymers. Synthetic substitutes for gelatin are e.g. polyvinyl alcohol, poly-N-vinyl pyrrolidone, polyvinyl imidazole, polyvinyl pyrazole, polyacrylamide, polyacrylic acid, and derivatives thereof, in particular copolymers thereof. Natural substitutes for gelatin are e.g. other proteins such as zein, albumin and casein, cellulose, saccharides, starch, and alginates. In general, the semi-synthetic substitutes for gelatin are modified natural products e.g. gelatin derivatives obtained by conversion of gelatin with alkylating or acylating agents, by grafting of polymerizable monomers on gelatin or prehardened gelatins with blocked functional groups as a consequence of this prehardening treatment, and cellulose derivatives such as hydroxyalkyl cellulose, carboxymethyl cellulose, phthaloyl cellulose, and cellulose sulphates. The binder should of course dispose of an acceptably high number of functional groups, which by reaction with an appropriate hardening agent can provide a sufficiently resistant layer after emulsion coating. Such functional groups are especially the amino groups, but also carboxylic groups, hydroxy groups, and active methylene groups. Another substitute for gelatin may be silica as has been described in the published EP-A's 0 392 092, 0 517 961, 0 528 476, 0 649 051 and 0 704 749. More particularly when colloidal silica sol is chosen as a protective colloid the reaction vessel can be prepared at lower temperatures as has been set forth in e.g. EP-A 0 682 287 and in the corresponding U.S. Pat. No.5,543,284. In these patents the particular conditions have been described in which cubic silver chloride emulsions having grains of a well-defined grain size are prepared. According to the method of the present invention the said binder material is a hydrophilic colloidal polymeric binder selected from the group consisting of gelatin, poly-N-vinylpyrrolidone, dextranes, polyacrylamide, cellulose compounds and derivatives thereof and copolymers of vinylidene chloride-methylacrylate-itaconic acid or methyl(meth)acrylate-butadiene-itaconic acid or a mixture (or mixtures) thereof.

If gelatin is further used, besides being used as protective colloid in the precipitation of cubic grains rich in silver chloride, the said gelatin may be used as peptizer or binder material after flocculation and washing. In order to get a qualitatively good flocculate flocculating agents as e.g. polystyrene sulphonic acid, etc., may be added before or after acidifying the emulsion, preferably at the precipitation temperature, followed by cooling up to e.g. room temperature and starting washing of the flocculate by means of a scrape rudder. By decantation of the aqueous phase rich in alkali halide (especially potassium chloride) salts and repeating addition of demineralized water and further washing (at least two, preferably three times or even more), this process can be performed discontinuously, in batch. Other possibilities are offered by filtration techniques, e.g. by dialysis, ultrafiltration etc. so that the emulsion may be washed to a desired pAg value without the requirement to be redispersed afterwards. Emulsion flocculates are preferably washed out by the addition of well-determined amounts of demineralized water, whether or not doped with small amounts of water-soluble salts like e.g. sodium or potassium chloride. By consecutive washing procedures in batch or continuously washing or by means of diafiltration or ultrafiltration the desired pH and/or pAg of the emulsion is reached in order to get a peptized emulsion, ready for getting chemically sensitized.

In case of gelatin for use as a protective colloid and/or binder material the ratio by weigth of gelatin to silver (expressed as equivalent amount of silver nitrate) is called “gesi” and is a characteristic feature of the emulsion. So after precipitation a gesi value of e.g. 0.15-0.25 may be reached, whereas after peptization, by addition of gelatin peptizer at an increased temperature up to about 38-48° C., the gesi value may have been increased up to a value of from 0.40 up to 0.60.

Further gelatin may be used as a binder material in the coated layers of the material (wherein a gesi value up to a value in the range from 0.8 to 1.2 may be calculated). The said gelatin providing colloidal stability of the cubic emulsion grains, peptizing ability or coating ability may be lime-treated or acid-treated. The preparation of such gelatin types has been described in e.g. “The Science and Technology of Gelatin”, edited by A. G. Ward and A. Courts, Academic Press 1977, page 295 and next pages. The gelatin may also be an enzyme-treated gelatin as described in Bull. Soc. Sci. Phot. Japan, N° 16, page 30 (1966). Preferably use is made of photographically inert gelatin in order to add a reproducible amount of chemical sensitizers in the following chemical sensitization step, wherefor the temperature of the reaction vessel should be increased up to 50-70° C., more preferably up to 50-60° C.

According to the method of the present invention, prior to chemical sensitization a compound releasing iodide ions is added, followed by a digestion period (about at least 5 minutes), before starting the chemical sensitization procedure, wherein said compound releasing iodide ions is selected from the group consisting of an alkali iodide salt, an I₃-complex and a fine-grained silver iodide emulsion, having emulsion grains of not more than 0.050 μm. Those compound(s) is (are), according to the method of the present invention added in an amount in order to have an average amount of iodide in the cubic crystals rich in silver chloride of not more than 3 mole %, based on silver. In a more preferred embodiment an average amount of iodide present in the cubic crystals rich in silver chloride does not exceed 1 mole % and is even more preferably in the range between 0.05 and 0.5 mole %.

After digestion of the emulsion crystals rich in silver chloride and enriched in silver iodide as set forth above, according the method of the present invention the step is performed of adding as chemical sensitizing agents consecutively, a gold compound, an oxidizing compound and a compound releasing sulphur, followed by chemically sensitizing by digestion (during a time dependent on the reaction temperature, which may vary from less than 1 hour at 70° C. up to about 4 hours at 50° C.) at a controlled temperature of said cubic emulsion crystals.

According to the method of the present invention as chemical sensitizing agents are added consecutively, a gold compound (like gold chloride acid or gold thiocyanide complex), an oxidizing compound (like the preferred toluene thiosulphonic acid salt, used as weakly oxidizing agent) and a compound releasing sulphur (like the preferred sodium thiosulphate pentahydrate). It is self-explaining that the compounds between brackets are not limited thereto. Moreover it is not excluded, in order to get an enhanced speed to make use of selenium compounds as e.g. triphenyl phosphor-selenide or even tellurium compounds, wherein said selenium and/or tellurium compounds may replace sulphur compounds partially. It is further not excluded to add small amounts (e.g. from 0.5 to 20 μmole per mole of silver) of iridium compounds (as e.g. potassium hexachloroiridate(III)) during and/or at the end of the precipitation step and/or in the chemical ripening step as this may lead to a positive effect on processing latitude, in that less differences in sensitivity and gradation are observed after fluctuations in short developing times within a range of 5 seconds and in processing temperature within a range of about 5° C. Supplying an iridium compound may appear just before supply of the silver for forming a localized phase under presence of an iridium compound, or immediately after said supply. E.g. when forming the localization phase with high silver bromide content by adding a water-soluble bromide solution, adding another solution which the solution was made to contain an iridium compound beforehand, or contained the iridium compound simultaneously is performed preferably.

Other suitable dopants used during precipitation or chemical ripening of cubic crystals rich in silver chloride may be Fe, Co, Ni, Ru, Rh, Pd, Os, Pt, Pb, Cd, Hg, Tl and Au.

A last step, of utmost importance in order to reach the objects of the present invention is the step of adding, immediately after ending said chemically sensitizing (digestion) step, of one or more mercaptotetrazole compounds according to the general formula (I) as has been extensively been set out before. The terminology “after ending said chemically sensitizing step” has, according to the method of the present invention, to be understood as adding said compound(s) just before, during or at the end of the cooling step following the digestion at the well-controlled higher temperatures as indicated above. In a preferred embodiment said compound(s) is added just before starting cooling the emulsion. Normally the chemically sensitized emulsion is cooled up to 45-38° C., followed by addition, if required, of further stabilizing compounds.

According to the present invention a silver halide material is provided, comprising one or more emulsions prepared according to the method described above, wherein said material is a color print material. It is not excluded however to use an emulsion, prepared according to the method of the present invention in other silver halide materials as e.g. a sound recording material, a black-and-white single-side coated radiographic, (micro)graphic or laser recording material. Preferably said material has a transparent support, selected from the group of support materials consisting of cellulose nitrate, cellulose acetate, polyvinylacetal, polystyrene, polyethylene terephthalate, poly(ethylene naphthalate), polycarbonate film and glass; polyethylene terephthalate (PET) being most preferred.

As has been mentioned in the background of the invention in one embodiment a silver halide material, wherein an emulsion prepared according to the present invention is present, is a color print material. Therein the emulsion prepared according to the method of the present invention is preferably coated in the blue sensitive layer thereof. In that case the emulsion is spectrally sensitized by addition of a blue sensitizing dye of the merocyanine type, given hereinafter and in the Examples (S-1), and wherein, in the alternative, the K⁺-salt thereof may be used.

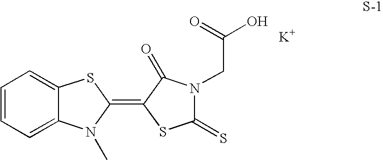

Photographic silver halide emulsion materials or elements according to the present invention, in favor of sharpness or image definition, comprise an antihalation undercoat or layer in order to reduce light scattering, wherein said antihalation undercoat is in direct contact with the subbing layer at the light-sensitive side of the transparent support or is separated from it by a thin indermediate gelatin layer. Advantages offered by antihalation layers are e.g. well-known from microfilms and from radiographic applications, offering a solution for the problem of image definition in circumstances wherein very high demands are posed as in single-side coated recording materials for mammography (see e.g. EP-A's 0 610 609,0 712 036 and 0 874 275) brought into contact with an intensifying screen at the side of the film support having the light-sensitive emulsion layer(s) or for laser recording as e.g. described in EP-A 0 610 608 and 0 794 456 for the registration of digitally stored images. As a function of the processing times and as a function of the need to have processed images free from residual stain or color the antihalation layer is present in the backing layer (for rapid processing applications) or as an antihalation undercoat at the light-sensitive side, wherein, from the point of view of reduction of light scattering, presence of an antihalation undercoat at the light-sensitive side is preferred.

Antihalation layers and dyes, useful in the material or element of the present invention, are e.g. merostyryl dyes, oxonol dyes, pyrazolones, pyrrols, thiophenes, etc., as those described in EP-A's 0 489 973, 0 586 748, 0 587 229, 0 587 230, 0 656 401, 0 724 191, 0 781 816 and 0 786 497.

Antihalation dyes, present in the antihalation undercoat covering the subbing layer at the light-sensitive side of the support of the material according to the present invention are non-spectrally sensitizing dyes which are widely used in photographic elements in order to absorb reflected and scattered light, in a limited or very broad wavelength range. Examples of the said dyes have been described e.g. in U.S. Pat. Nos. 3,560,214 and 4,857,446 and in EP-A's given above. The filter or accutance dye(s) can be coated in layers of photographic elements in the form as has been described in EP-A's 0 384 633, 0 323 729, 0 274 723, 0 276 566, 0 351 593; in U.S. Pat. Nos. 4,900,653; 4,904,565; 4,949,654; 4,940,654; 4,948,717; 4,988,611 and 4,803,150; in Research Disclosure Item 19551 (July 1980); in EP-A 0 401 709 and in U.S. Pat. No. 2,527,583, these examples however being not limitative. More than one antihalation layer is optionally present, e.g. in multilayer materials wherein the light-sensitive layer, as set forth hereinbefore, is part of a multilayer arrangement, optionally including one or more intermediate layers between light-sensitive emulsion layers, wherein said emulsion layers have been made sensitive by spectral sensitization, to differing wavelength ranges, e.g. being sensitive to blue, green and red light as is well-known from color sensitive materials, and wherein the said intermediate layers may contain antihalation dyes in order to enhance sharpness or image definition in a limited wavelength range as described e.g. in EP-A 0 252 550 for color print materials and in EP-A 0 582 000 for color negative recording materials.

According to the present invention an element is provided, wherein said antihalation undercoat comprises one or more dye(s), at least one yellow non-diffusing dye that absorbs blue light and is removable and/or decolorizable in a processing bath, and is chosen from the group consisting of merostyryl dyes and monomethine oxonol dyes. Preferably said merostyryl dyes are pyrazolone-5 merostyryl dyes having a hydroxybenzal moiety and at least one carboxy or carbamoyl group on the pyrazolone ring or symmetrical monomethine oxonols of pyrazolone. Particularly preferred is a yellow non-diffusing merostyryl dye (D-I) (gelatinous or colloidal silica) solid particle dispersion, as disclosed e.g. in EP-A 0 569 074.

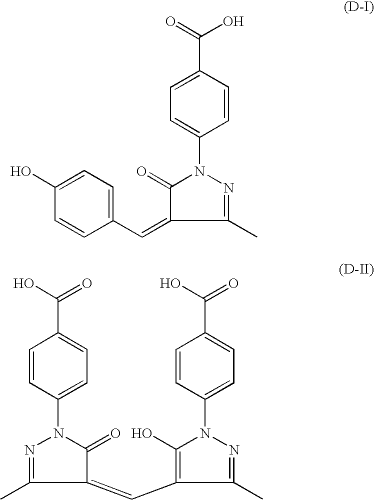

According to another embodiment of the present invention an element is provided, wherein said element is a motion picture projection color print film material, comprising a transparent film support and coated thereon in succession, a blue-sensitive silver halide emulsion layer comprising a yellow-forming coupler, a red-sensitized silver halide emulsion layer comprising a cyan-forming coupler, an intermediate layer, a green-sensitized silver halide emulsion layer comprising a magenta-forming coupler, and an antistress layer, wherein between said support and said blue-sensitive silver halide emulsion layer a yellow antihalation undercoat is provided, which comprises at least one yellow non-diffusing dye that absorbs blue light and is removable and/or decolorizable in a processing bath. As already set forth hereinbefore said at least one dye is preferably chosen from the group consisting of a merostyryl dye and a monomethine oxonol dye, preferably being a (symmetrical) monomethine oxonol, and even more preferably a pyrazolone-type monomethine oxonol, whereas preferred merostyryl dyes are of the pyrazolone-5-type, having a hydroxybenzal moiety and at least one carboxy or carbamoyl group on the pyrazolone ring.

In still another embodiment said element is a color print film material, wherein between said blue-sensitive silver halide emulsion layer and said red-sensitized silver halide emulsion layer a bluish antihalation intermediate layer is provided, which comprises at least one blue non-diffusing dye that absorbs red light and is removable and/or decolorizable in a processing bath. Said at least one blue non-diffusing dye is at least one pentamethine oxonol-type barbituric acid derivative dye, without however being limited thereto.

Preferred pentamethine oxonols of the barbituric acid type preferably have at least one halogen atom, hydroxy, alkyl, alkoxy, carboxy,carbamoyl, sulphamoyl, alkoxycarbonyl, aryloxycarbonyl, alkoxysulphonyl, aryloxysulphonol, and heterocyclylsulphonyl, e.g. o-sulphamoyl-phenyl, p-methoxy-phenyl, and 3-hydroxy-4-carboxyphenyl groups. As an antihalation dye in a layer under the blue-sensitive layer the preferred pentamethine oxonol dye (D-III) may advantageously be used, as illustrated in the Examples, without however being limited thereto, as has been illustrated in EP-A 0 252 550 and the corresponding U.S. Pat. No. 4,770,984, wherein the preferred layer arrangement is claimed.

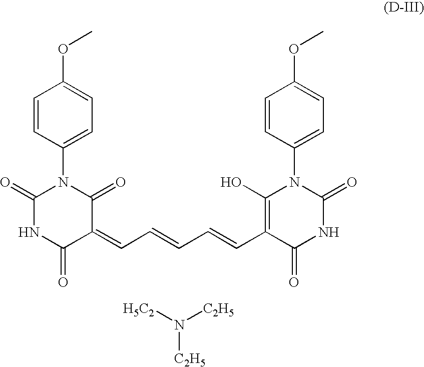

In one embodiment of the present invention as it is an object to provide a photographic film material wherein an emulsion is present, prepared according to the method of the present invention and wherein said emulsion is preferably coated in the blue sensitive layer thereof, and as moreover in a preferred embodiment said film material is a motion picture print film, without a “carbon black” backing layer, which does not show, after processing, problems of loss of conductivity and loss of durability, especially with respect to scratching stability, said film material comprises, on a light-sensitive side of a transparent polyester support, in order, an electrically conductive subbing layer, an antihalation undercoat, a light-sensitive emulsion layer or multilayer arrangement, optionally including one or more intermediate, non-light-sensitive layers between emulsion layers in said multilayer arrangement, and a protective overcoat; and on a backing layer side opposite thereto, in order, a subbing layer containing a lubricant and a topcoat layer, wherein, on the light-sensitive side of said element said subbing layer comprises an antistatic agent providing a substantially unchanged electrical resistivity of the said element before and after processing of said material, and said antihalation undercoat optionally comprises a high temperature boiling solvent; and wherein on the backing layer side a friction coefficient of the backing layer versus stainless steel remains unchanged in the range between 0.20 and 0.30 before and after processing of said material, even after removal of the said topcoat layer during processing in an alkaline developer.

The conductive subbing layer coated on the light-sensitive side of the transparent polyester support shows about unchanged antistatic properties due to the presence of an electronically conductive compound providing, before an after processing, where the electrical resistivity of this subbing layer is situated between 1×10⁵ and 1×10¹² Ω/□, more preferably between 1×10⁷ and 1×10¹⁰ Ω/□, resulting in an electrical resistivity of the emulsion side of the element or material between 1×10⁹ and 1×10¹⁴ Ω/□. The expression “substantially unchanged” indicates that changes in electrical resistivity are limited, in that differences before and after processing are less than a factor of 100 (10²) Ω/□, and more preferably less than a factor 10 Ω/□. In such an electrically conductive subbing layer showing fairly unchanged antistatic properties an electrically-conductive agent is dispersed in a binder, the electrically conductive agent being selected from the group consisting of electronic conductive metal-containing particles, metal oxides containing oxygen deficiencies, conductive nitrides, conductive carbides, conductive bromides, fibrous electronic conductive powders, conductive polyacetylenes, conductive polythiophenes and conductive polypyrroles, wherein polythiophenes, and more particularly PEDT (poly ethylene dioxy thiophene) is most preferred. Electrically-conductive agents may be present in amounts of from 0.5 mg/m2 to about 1000 mg/m2, depending on coating ability.

In the backing layer of the materials according to the present invention substantially changed electrical resistivity is measured before and after processing, due to presence of electrically-conductive agents dispersed in a binder, like the electrically conductive agent comprising inorganic salts, alkali metal salts, ionic conductive polymers, polymeric electrolytes containing alkali metal salts or colloidal metal oxide sols, and wherein the binder further comprises interpolymers of ethylenically unsaturated monomers, cellulose derivatives, polyurethanes, polyesters, hydrophilic colloids, polyvinyl alcohol or polyvinyl pyrrolidone. The electrically-conductive layer or layers not having permanent antistatic properties further comprise cross-linking agents coating aids, surfactants, dispersing aids, coalescing aids, biocides, matte particles or lubricants. Thanks more particularly to the presence of a lubricant in the subbing layer at the side of the backing layer opposite to the light-sensitive side of the polyester support and to the removal during processing of the topcoat layer only, on the said backing layer side, the friction coefficient of the backing layer versus stainless steel remains about unchanged in the range between 0.20 and 0.30, which is an indispensble asset in order to avoid problems during manufacturing, i.a. during processing of the exposed film material as well as during projection of the processed material) of the film, more particularly with respect to scratchability.

Otherwise presence of a high temperature boiling solvent, preferably in an amount of from 0.1 to 0.5 g/m², in the antihalation undercoat at the light-sensitive side of the polyester support, and, optionally, in an amount of from 0.2 to 1.0 g/m² in the blue-sensitive emulsion layer of a color print material, provides an optimized laser subtitling quality, whereas presence of permanent antistatic agent(s) in the subbing layer avoids charging of the layers and dust attraction, both measures avoiding optically disturbing effects.

With respect to laser subtitling ability of color print materials—extensively set out in EP-A 0 782 045, corresponding with U.S. Pat. No. 5,981,155 and the high quality, i.a. good definition of the figures, burned through the whole layer package of the color print material can thus be obtained. All those features, providing an excellent color print materials have been extensively described in EP-A 1 202 115.

In another embodiment the photographic element according to the present invention comprises a support, at least one silver halide image forming layer superposed on the support, a first transparent electrically conductive layer comprising an electrical resistivity of less than 1×10⁹ Ω/□ before photographic processing and an electrical resistivity of greater than 1×10¹¹ Ω/□ after photographic processing; and a second transparent electrically conducting layer comprising an electrical resistivity of between 1×10⁹ Ω/□ and 10¹¹ Ω/□ both before and after photographic processing as has been set out in U.S. Pat. No. 6,140,030.

In a preferred embodiment of the present invention wherein the material is a color print material, processing proceeds in automatic processors. In case of a color print material, it is desirable to carry out bleaching fixing processing after color development from the purpose of quick processing. When especially the cubic grain emulsion rich in silver chloride, as for pH of a bleach fix bath, about 6.5 or less is desirable for good desilvering purposes, whereas about at most 6.0 is even more preferred.

The multi-layered color print material, as preferred according to the present invention, is preferably used in combination with a negative working black-and-white silver halide motion picture sound recording film in order to provide the color print film with a soundtrack of high quality. Said sound recording film preferably comprises a support bearing at least one silver halide emulsion layer, wherein said film is spectrally sensitized both above and below 600 nm as disclosed in U.S. Pat. No. 5,955,255, thus being panchromatically sensitized as previously described in GB 449,546 and the corresponding FR 784,027. Such film may be used for recording multiple optical soundtracks by exposing said film with a first source of radiation having a peak wavelength of less than or equal to 600 nm, recording a second digital soundtrack by exposing said film with a second source of radiation having a peak wavelength of greater than 600 nm, and processing said exposed film to form first and second digital soundtrack silver images. Suitable antihalation dyes, selected e.g. from the dyes or pigments given hereinbefore may be advantageously be coated in an antihalation undercoat of that sound recording film. Typical black- and-white sound recording films designed for recording analog soundtracks comprise a relatively fine grain, having e.g. a grain size less than 0.35 μm for a monodispersed silver halide emulsion, which provides a high contrast overall gradient being greater than 3.7, more preferably greater than 3.8 and even more preferably greater than 3.9, desirable for recording the soundtrack with sharp edges. In order to reach such high gradations in a short processing time it is advantageous to develop said sound recording film having fine emulsion grains in a rapid access developer known e.g. from graphic arts. Short processing times may provide an opportunity to make use in the sound laboratory of compact processors.

White light sources such as tungsten lamps have conventionally been used to record analog soundtracks. Accordingly, the native sensitivity of many silver halide emulsions in the blue region of the electromagnetic spectrum (e.g. 380-500 nm) has been sufficient for such white light recording. Where additional speed is desired for white light recording or where emulsions are used which lack sufficient native sensitivity in the visible light region, sound recording films have been sensitized for analog recording with blue and/or green sensitizing dyes. Otherwise digital soundtrack recording is typically performed by exposing a sound recording film to a modulated coherent radiation light source having a narrow band width, such as a modulated laser beam or light emitting diode or diode array. So sound recording films have been made which are optimally spectrally sensitized to provide a peak sensitivity to match a particular digital recording device, along with providing adequate sensitivity for recording anolog soundtracks with white light sources.

In another embodiment a soundtrack image in a motion picture print film may, apart from originating from the panchromatic black-and-white sound recording film spectrally sensitized both above and below 600 nm, alternatively comprise e.g. a soundtrack negative in a chromogenic soundtrack recording film by exposing said film and processing said exposed film with a color developer process to form a dye soundtrack negative, and printing a soundtrack onto a negative-working motion picture color print film by exposing the motion picture print film through the dye soundtrack negative and processing the exposed print film to form a positive soundtrack. The light-sensitive emulsion layer of the sound recording film preferably comprises green or red light-sensitive silver halide emulsion grains and a cyan or magenta dye-forming coupler in the substantial absence of yellow dye-forming coupler. Most preferred in that case is a light-sensitive emulsion layer of the sound recording film comprising green and red light-sensitive silver halide emulsion grains and cyan and magenta dye-forming couplers in the substantial absence of yellow dye-forming coupler as has been disclosed in U.S. Pat. No. 5,856,057. Dyes presented above may advantageously be used in an antihalation layer of such a chromogenic sound film.

### EXAMPLES

While the present invention will hereinafter be described in connection with preferred embodiments thereof, it will be understood that it is not intended to limit the invention to those embodiments.

Emulsion A:

Making use of the double jet precipitation technique a 100% AgCl emulsion having an particle diameter of 0.6 μ was precipitated. After washing and redispersing the emulsion contained about 1.2 mole of AgNO₃/kg. The weight ratio of gelatin to AgNO₃ amounts to 0.4.

The emulsion was divided into 5 equal portions and chemically sensitized in the following way :

Chemical Sensitization of Part A-1 :

This emulsion part was sensitized at a pH of 5.1. First of all 3 mmole of KI/mole of AgNO₃ were added. After 5 minutes 3.7 μmole of HAuCl₄ per mole of AgNO₃; 9.7 μmole of toluene thiosulphonic acid per mole of AgNO₃ and 12 μmole of Na₂S₂O₃ per mole of AgNO₃ were added. Chemical sensitization was performed at 70 C. for approximately 1.5 hours.

Chemical Sensitization of Part A-2 :

Just as for Part A-1, but immediately after chemical sensitization, 0.44 mmole of compound (I.1) was added per mole of Ag.

Chemical Sensitization of Part A-3 :

Just as for Part A-1, but immediately after chemical sensitization, 0.3 mmole of compound (I.10) per mole of Ag was added.

Chemical Sensitization of Part A-4 :

Just as for Part A-1 but immediately after chemical sensitization 0.37 mmole of compound (I.8) per mole of Ag was added.

Chemical Sensitization of Part A-5 :

Just as for Part A-1 but immediately after chemical sensitization 0.2 mmole of compound (I.12) per mole of Ag was added.

Photographic evaluation of these emulsion Parts A1 to A5 was performed by incorporating the emulsions in a blue-sensitive recording material having following composition :

Layer 1-Antihalation undercoat

| | | |
|---|---|---|
| Gelatin | 1000 | mg/m2 |
| Solid Particle Antihalation Dye (AH-1) | 280 | mg/m2 |
| Cetiol S | 200 | mg/m2 |

Layer 2-Blue Sensitive Layer

| | | |
|---|---|---|
| Gelatin | 2100 | mg/m2 |
| Emulsion Parts (A1-A6) | 4050 | mg/m2 |
| Blue-sensitizer S-1 | 1.3 | mg/m2 |
| Yellow dye-forming Coupler Y-1 | 1345 | mg/m2 |
| Soluble Filter Dye FD-1 | 120 | mg/m2 |

Layer 3-Protective Overcoat

| | | |
|---|---|---|
| Gelatin | 800 | mg/m2 |
| Poly-dimethylsiloxane lubricant (BAYER) | 20 | mg/m2 |
| Polymethylmethacrylate matte beads (3 μm) | 3 | mg/m2 |
| Cetiol 5 | 50 | mg/m2 |
| Fluoro Chemical FC143 from 3M | 30 | mg/m2 |
| Anionic surfactant (dodecyl arylsulphonate, sodium salt) | 20 | mg/m2 |
| Triazin-hardener T-S | 88 | mg/m2 |

These photographic materials were coated on a subbed polyethylene terephthalate support.

Formulae corresponding with the compounds AH-1, AH-2, Y-1, FD-1 and T-S have been given hereinafter.

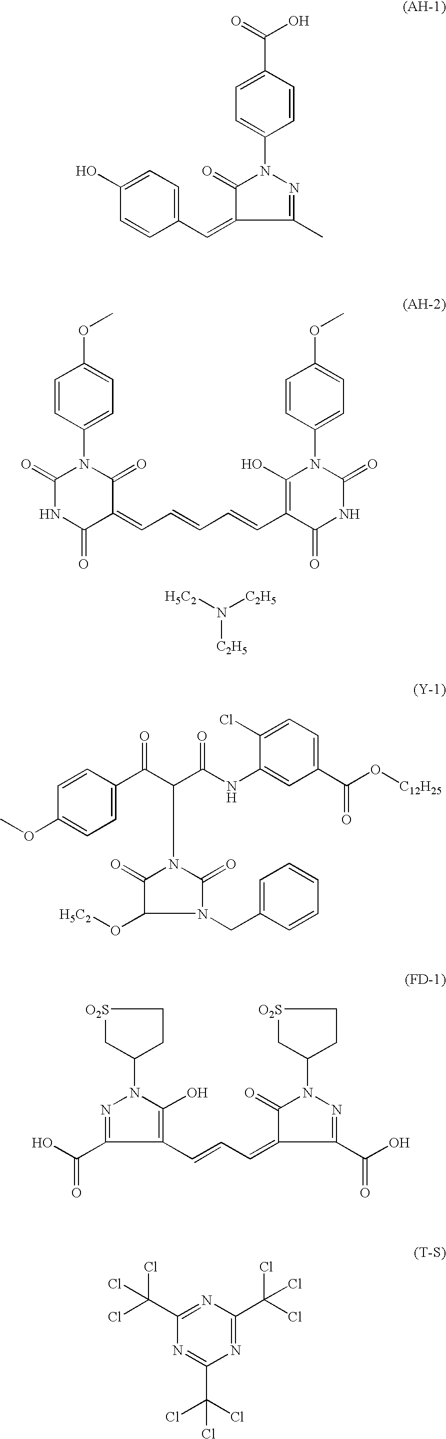

Photographic properties and, more particularly, latent image stability, was evaluated by exposing the materials through a step wedge for 10 ms. These materials were processed later on according to the standard Kodak ECP-2B Color Print Development Process. Between exposing and processing the different materials were kept at room temperature during 10 days. In order to be able to give an indication for latent image stability, the same materials were processed immediately after exposure, the figure thus obtained offering a reference value: differences in sensitivity between a material processed immediately after exposure and a material processed 10 days after exposure, expressed as “Δ LogE” was taken as a measure for latent image stability. Data thus obtained have been summarized in Table I.

TABLE I

| Chemical | sensitization | sensitivity | ΔLog E |
|---|---|---|---|
| A-1 | comparative | 119 | −66 |
| A-2 | invention | 90 | −3 |
| A-3 | invention | 101 | −6 |
| A-4 | invention | 92 | −4 |
| A-5 | invention | 82 | −4 |

Emulsion B:

Making use of the double jet precipitation technique a 100% AgCl emulsion having an particle diameter of 0.3 μ was precipitated. After washing and redispersing the emulsion contained about 1.2 mole of AgNO₃/kg. The weight ratio of gelatin to AgNO₃ amounts to 0.4.

The emulsion was divided into 2 equal portions and chemically sensitized in the following way :

Chemical Sensitization of Part B-1 :

This emulsion part was sensitized at a pH of 5.1. First of all 3 mmole of KI/mole of AgNO₃ were added. After 5 minutes 10 μmole of HAuCl₄ per mole of AgNO₃; 16 μmole of toluene thiosulphonic acid per mole of AgNO₃ and 8.75 μmole of Na₂S₂O₃ per mole of AgNO₃ were added. Chemical sensitization was performed at 70 C. for approximately 1.5 hours.

Chemical Sensitization of Part B-2 :

Just as for Part B-1, but immediately after chemical sensitization, 0.88 mmole of compound (I.1) per mole Ag was added.

A photographic blue-sensitive recording material having the following composition is produced on a subbed polyester support.

Layer 1-antihalation undercoat

| | | |
|---|---|---|
| Gelatin | 1000 | mg/m2 |
| Solid Particle Antihalation Dye (AH-1) | 280 | mg/m2 |
| Cetiol S (oilformer, surfactant from HENKEL) | 200 | mg/m2 |

Layer 2-Blue Sensitive Layer

| | | |
|---|---|---|
| Gelatin | 2100 | mg/m2 |
| Emulsion (Parts B1-B2) | 4050 | mg/m2 |
| Blue-sensitizer S-1 | 1.3 | mg/m2 |
| Yellow dye-forming Coupler Y-1 | 1345 | mg/m2 |
| Soluble Filter Dye FD-1 | 120 | mg/m2 |

Layer 3-Protective Overcoat

| | | |
|---|---|---|
| Gelatin | 800 | mg/m2 |
| Polydimethylsiloxane lubricant (BAYER) | 20 | mg/m2 |
| Polymethylmethacrylate matte beads (3 μ) | 3 | mg/m2 |
| Cetiol S (oilformer, surfactant from HENKEL) | 50 | mg/m2 |
| Fluoro Chemical FC143 from 3M | 30 | mg/m2 |
| Anionic surfactant (dodecyl arylsulphonate, sodium salt) | 20 | mg/m2 |
| Triazin-hardener T-S (see above) | 88 | mg/m2 |

The formula of blue-sensitizer S-1 has been given hereinafter:

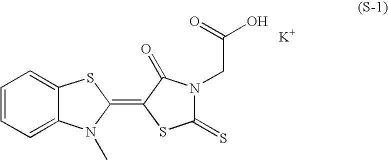

The latent image stability was evaluated by exposing the materials through a step wedge for 10 ms and processing these materials according to the standard Kodak ECP-2B Color Print Development Process.

Between exposure and processing the different materials were kept at room temperature during 10 days. In order to obtain a reference figure, the same materials were processed immediately after exposure.

The difference in sensitivity between a material processed immediately after exposure and a material processed 10 days after exposure, called “Δ LogE”, was taken as a measure for latent image stability.

TABLE II

| Chemical | sensitization | sensitivity | ΔLog E |
|---|---|---|---|
| B-1 | comparison | 123 | −69 |
| B-2 | invention | 115 | −8 |

Having described in detail preferred embodiments of the current invention, it will now be apparent to those skilled in the art that numerous modifications can be made therein without departing from the scope of the invention as defined in the appending claims.

What is claimed is:

1. A method of preparing an emulsion in an aqueous medium containing a protective colloid, said method comprising as consecutive steps
precipitating cubic emulsion crystals rich in silver chloride;
flocculating, washing and redispersing by addition of a binder material;
adjusting pH and pAg;
adding, prior to chemical sensitization, a compound releasing iodide ions,
adding as chemical sensitizing agents consecutively, a gold compound, an oxidizing compound and a compound releasing sulphur;
chemically sensitizing said cubic emulsion crystals;
characterized in that, after ending said chemically sensitizing step, addition of a compound according to the general formula (I) is performed, 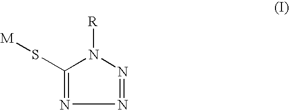
wherein R represents a substituted aryl and wherein M represents a hydrogen atom, an alkali metal atom or an ammonium group.

2. Method according to claim 1, wherein said compound according to the general formula (I) is an acetamidophenyl mercaptotetrazole.

3. Method according to claim 1, wherein said compound according to the general formula (I) is added to the said emulsion in an amount in a range of from 0.01 up to 1 mmole per mole of silver halide.

4. Method according to claim 2, wherein said compound according to the general formula (I) is added to the said emulsion in an amount in a range of from 0.01 up to 1 mmole per mole of silver halide.

5. Method according to claim 1, wherein said compound releasing iodide ions is selected from the group consisting of an alkali iodide salt, an I₃-complex and a fine-grained silver iodide emulsion, having emulsion grains of not more than 0.050 μm, and is added in an amount in order to have an average amount of iodide in the cubic crystals rich in silver chloride in an amount of not more than 3 mole %, based on silver.

6. Method according to claim 2, wherein said compound releasing iodide ions is selected from the group consisting of an alkali iodide salt, an I₃-complex and a fine-grained silver iodide emulsion, having emulsion grains of not more than 0.050 μm, and is added in an amount in order to have an average amount of iodide in the cubic crystals rich in silver chloride in an amount of not more than 3 mole %, based on silver.

7. Method according to claim 3, wherein said compound releasing iodide ions is selected from the group consisting of an alkali iodide salt, an I₃-complex and a fine-grained silver iodide emulsion, having emulsion grains of not more than 0.050 μm, and is added in an amount in order to have an average amount of iodide in the cubic crystals rich in silver chloride in an amount of not more than 3 mole %, based on silver.

8. Method according to claim 1, wherein said protective colloid is selected from the group consisting of gelatin, silica sol, starch or a mixture thereof.

9. Method according to claim 1, wherein said binder material is a hydrophilic colloidal polymeric binder selected from the group consisting of gelatin, poly-N-vinylpyrrolidone, dextranes, cellulose compounds and derivatives thereof and copolymers of vinylidene chloride-methylacrylate-itaconic acid or methyl(meth)acrylate-butadiene-itaconic acid or a mixture thereof.

10. Method according to claim 8, wherein gelatin is selected from the group of consisting of natural gelatin and modified gelatin.

11. Method according to claim 9, wherein gelatin is selected from the group of consisting of natural gelatin and modified gelatin.

11. Method according to claim 1, wherein said cubic emulsion crystals rich in silver chloride have an average edge length of from 0.1 μm up to 1.0 μm.

12. Method according to claim 2, wherein said cubic emulsion crystals rich in silver chloride have an average edge length of from 0.1 μm up to 1.0 μm.

13. Method according to claim 3, wherein said cubic emulsion crystals rich in silver chloride have an average edge length of from 0.1 μm up to 1.0 μm.

14. Method according to claim 1, wherein said cubic emulsion grains rich in silver chloride have at least 50 mole % of silver chloride, based on silver; and wherein silver bromide, if present, is present in a molar amount of not more than 20 mole %, based on silver.

15. Method according to claim 2, wherein said cubic emulsion grains rich in silver chloride have at least 50 mole % of silver chloride, based on silver; and wherein silver bromide, if present, is present in a molar amount of not more than 20 mole %, based on silver.

16. Method according to claim 3, wherein said cubic emulsion grains rich in silver chloride have at least 50 mole % of silver chloride, based on silver; and wherein silver bromide, if present, is present in a molar amount of not more than 20 mole %, based on silver.

17. A silver halide material comprising one or more emulsions prepared according to the method according to claim 1.

18. A silver halide material comprising one or more emulsions prepared according to the method according to claim 2.

19. A silver halide material comprising one or more emulsions prepared according to the method according to claim 3.

20. A silver halide material comprising one or more emulsions prepared according to the method according to claim 5.

21. A silver halide material comprising one or more emulsions prepared according to the method according to claim 8.

22. A silver halide material comprising one or more emulsions prepared according to the method according to claim 9.

23. A silver halide material comprising one or more emulsions prepared according to the method according to claim 11.

24. A silver halide material comprising one or more emulsions prepared according to the method according to claim 14.
